(19) United States
(12) Patent Application Publication
(10) Pub. No.: US 2022/0322877 A1
(43) Pub. Date: Oct. 13, 2022

(54) MODULAR COOKING APPLIANCE

(71) Applicant: Way Interglobal Network, LLC, Elkhart, IN (US)

(72) Inventors: Christopher S. Greer, Syracuse, IN (US); Tom Halbert, Elkhart, IN (US); Jarvis Hunt, Elkhart, IN (US)

(73) Assignee: Way Interglobal Network, LLC, Elkhart, IN (US)

(21) Appl. No.: 17/226,128

(22) Filed: Apr. 9, 2021

(51) Int. Cl. A47J 37/07; A47J 37/06; F24C 15/00; F24C 15/10; A21B 1/33

(52) U.S. Cl. CPC A47J 37/0786; A47J 37/0713; A47J 37/0682; A47J 37/0658; A47J 37/0647; A47J 37/0664; F24C 15/007; F24C 15/10; A21B 1/33; A47J 2201/00

(57) ABSTRACT

A modular cooking appliance for cooking a variety of foods has interchangeable tops and a base to receive the tops. The base has a burner that is fed from a fuel supply and controlled by a valve. The interchangeable tops mate to an open top. One of the interchangeable tops is a grill grate that fits in the open top. Another interchangeable top is a griddle with a flat cooking surface. The griddle mates to the open top and is kept spaced from the base to allow exhaust gases to escape. Another interchangeable top is a pizza oven with a stone portion and a dome portion. The stone portion directs exhaust gases from the burner into the dome portion.

### BACKGROUND OF THE INVENTION

This present disclosure relates to portable outdoor cooking appliances, typically grills or similar appliances taken camping. Other grills are a single function device, capable of cooking food on a grate, with a heat source under the grate. With the expansion of gourmet and health-conscious foods and the desire of people to consume them as they travel, an increased desire to cook different types of foods while traveling is emerging. Some desire to cook items on a grill, others desire to cook on a griddle, and some may desire to cook a pizza. While traveling, space is a major concern, so traveling with three individual cooking appliances consumes valuable space. This puts the user in a position where they either narrow their variety of food while traveling or use valuable storage space for a variety of bulky cooking appliances. Other devices attempt to solve this problem by adding components that would fit on an existing grill, such as an add-on griddle attachment or pizza oven that sits on top of the grill. These devices inherently involve compromises in cooking efficiency, storage, or compatibility. An improved device is needed.

### SUMMARY OF THE INVENTION

The present disclosure describes a modular cooking appliance with a common base and interchangeable tops. The common base has a heating element controlled by a valve. The base has receivers to locate and secure the interchangeable tops. One of the interchangeable tops is a grill grate for open-flame cooking. A second interchangeable top is a griddle that provides a flat surface with a drain for grease. The drain in the griddle aligns with a grease trap located in the common base when secured. A third interchangeable top is a pizza oven. Optionally, the pizza oven top and griddle top may be implemented without having to remove the grill grate. The baffle and/or grate may be removed if the user desires more direct heat to the griddle or pizza oven stone.

### BRIEF DESCRIPTION OF THE DRAWINGS

FIG. 1 is a front isometric view of the appliance showing different interchangeable tops;

FIG. 2 is a front isometric view of the base of the cooking appliance set up as a grill;

FIG. 3 is an exploded view of the base as shown in FIG. 2;

FIG. 4 is a front isometric view of the base of the cooking appliance set up as a griddle;

FIG. 5 is a front isometric view of the base set up as a grill as shown in FIG. 2 with the griddle top aligned to be assembled thereto;

FIG. 6 is a side section view 6-6 of the device as shown in FIG. 4 with the baffle and grate removed;

FIG. 7 is a front isometric view of the base of the cooking appliance set up as a pizza oven;

FIG. 8 is a front isometric view of the device as shown in FIG. 7 with the pizza oven aligned to be assembled to the base;

FIG. 9 is a front section view 9-9 of the device as shown in FIG. 7; and

FIG. 10 is a rear isometric section view 10-10 of the device as shown in FIG. 7.

### DESCRIPTION OF THE PREFERRED EMBODIMENT

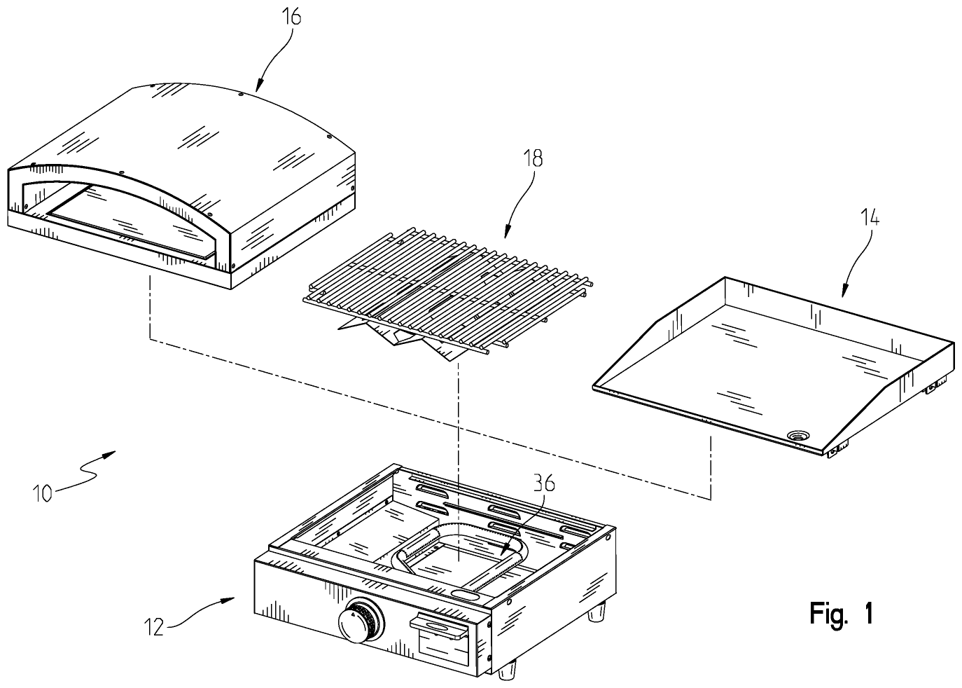

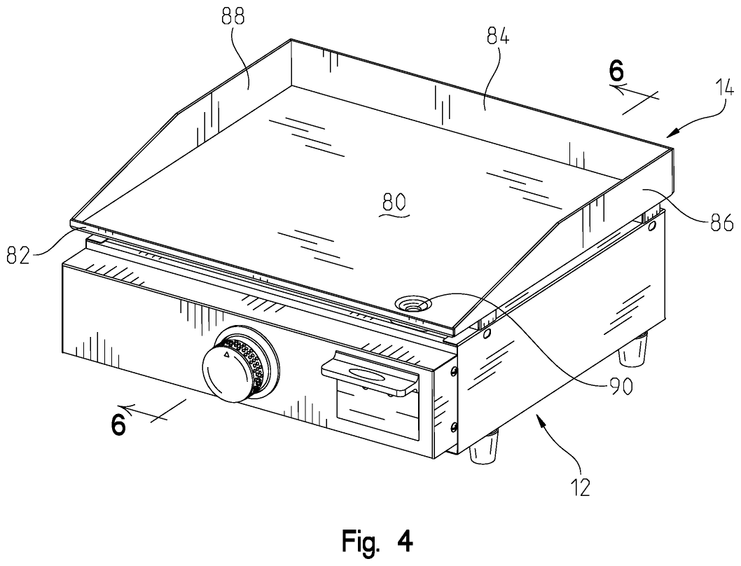

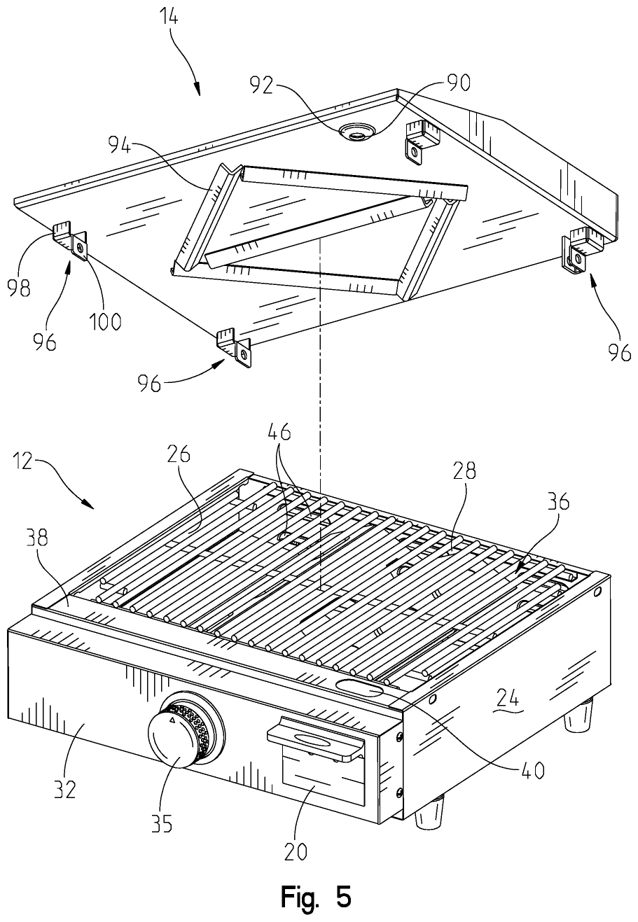

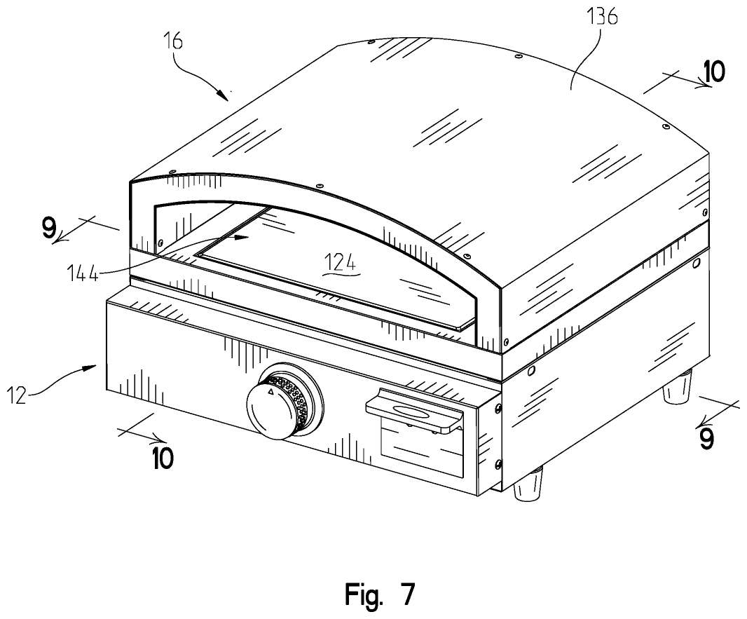

A modular cooking appliance 10 is shown in FIGS. 1-10. The appliance 10 has a base 12 that is designed to be used with interchangeable tops, such as a griddle 14, pizza oven 16, or grill grate 18. The appliance 10 is fed with fuel, such as natural gas or propane. The interchangeable tops securely mate to the base 12 so the user can cook different types of foods. The griddle 14 is a flat surface that drains to a grease trap 20 located in the base. The pizza oven 16 is a shielded cooking cavity with a front opening. The grill grate 18 can be used for open flame grilling.

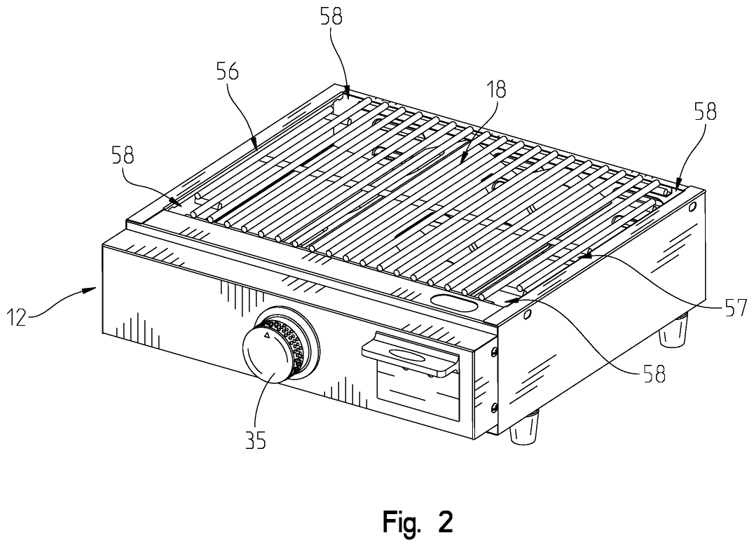

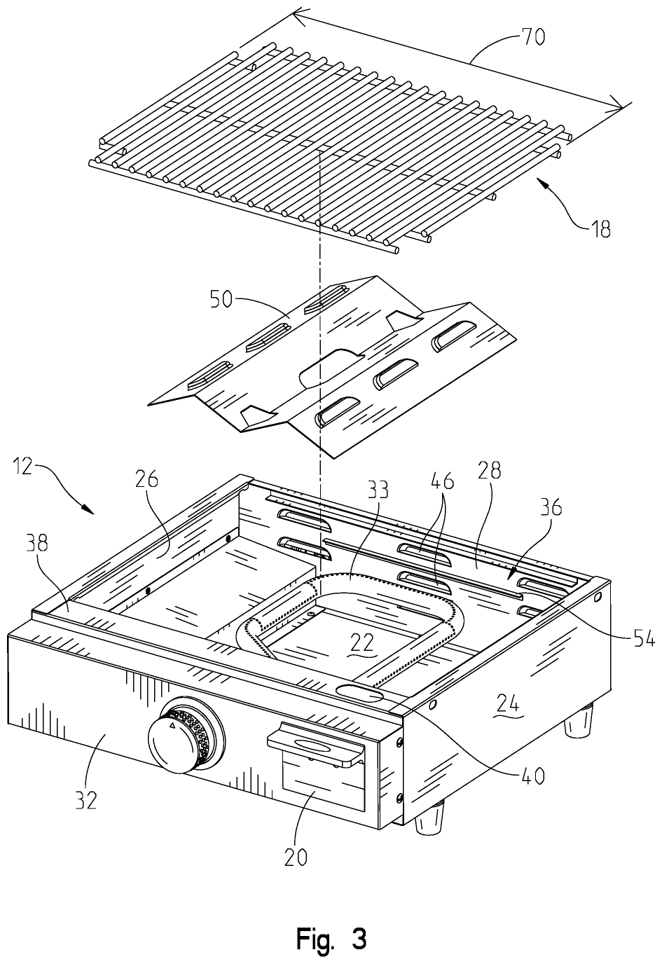

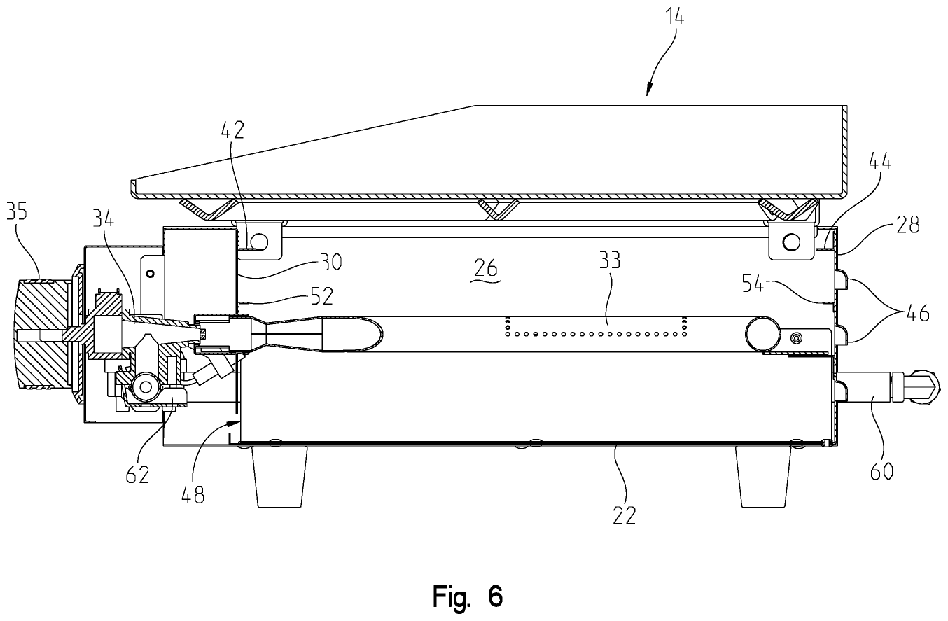

The base 12, shown in FIGS. 2-3, has a bottom wall 22 that is affixed to side walls 24, 26, a back wall 28, and a front wall 30. The side and back walls are visible from the outside of the base, but the front wall 30 is hidden behind a control bezel 32. The bezel 32 and front wall 30 have aligned apertures to receive the grease trap 20. The walls 22, 24, 26, 28, 30 form the firebox with a cooking opening 36 on top. The firebox holds a burner 33 that is connected to a gas valve 34. The gas valve 34 is located between the bezel 32 and front wall 30, controlled by knob 35 and shown in FIG. 6. The cooking opening 36 is sized and structured to receive the different interchangeable tops. Surrounding the cooking opening 36 is a top surface 38. The top surface 38 is formed by portions of the side walls 24, 26, front wall 30 and back wall 28. The top surface 38 includes a grease aperture 40 that is located directly over the open top of the grease trap 20. To provide a source of fresh air for combustion, the back wall 28 has vents 46 and a gap 48 between the front wall 30 and the bottom wall 22. Directly inside the cooking opening 36 and offset from the top surface 38 are support walls 42, 44. The front support wall 42 is affixed to the front wall 30 and the rear support wall 44 is affixed to the back wall 28.

A flame baffle 50 over the burner 33 is held in place with a shelf 52 that is affixed to the front wall 30 and a shelf 54 that is affixed to the back wall 28. The flame baffle 50 rests on the shelves 52, 54 and is lifted off for cleaning or if a more direct flame from the burner 33 is desired by the user.

The gas valve 34 is connected to a fuel supply line 60, which is connected to a fuel source, such as a portable fuel tank or fuel line connected to a tank onboard the mobile living quarters (not shown). The fuel supply line 60 is connected to a regulator 62 before reaching the gas valve 34. The regulator 62 modulates the fuel pressure to provide stable fuel pressure for the gas valve 34 and burner 33. As is well-known in the art, the burner 33 is connected to the gas valve 34 but also includes a starter/pilot device. The starter/pilot device allows the user to ignite the burner 33 after igniting a smaller flame that is adjacent the burner 33. While the base 12 shows a single burner, it is contemplated that multiple burners could be implemented, either controlled individually or in unison.

The grill grate 18 is designed to fit in the cooking opening 36 and be supported by the front and rear support walls 42, 44. As installed, the grill grate 18 is substantially flush with the top surface 38. As shown, the grill grate 18 is an assembly of stiff wire welded together into a flat structure forming elongate openings, but other structures are contemplated. The grill grate 18 could be cast iron, stamped sheet metal, or made from other common grate materials or manufacturing methods. The grill grate 18 has a width 70 that is less than the width of the cooking opening 36, which creates receiving gaps 56, 57. The receiving gaps 56, 57 allow for one of the interchangeable tops to be located and aligned to the base 12 while the grate 18 is left in place. The grate 18 stops short of filling the corners of the cooking opening 36, creating alignment pockets 58, as shown in FIG. 2.

The griddle 14 is a flat cooking surface 80 with border walls that surround it. The front border wall 82 is much shorter than the rear border wall 84. The side border walls 86, 88 join the front to the rear border walls. The cooking surface 80 has a drain aperture 90 that aligns with the grease trap 20 when the griddle 14 is mated to the base 12. The border walls are sealed to each other and to the cooking surface 80. The drain aperture 90 has a funnel portion 92 to prevent incorrect draining when the base 12 is not exactly level. On the opposite side of the flat cooking surface 80 are structural reinforcements 94 to prevent distortion and maintain the flatness of the cooking surface 80, even when heated. Located near the corners of the griddle 14 are locating feet 96. Each locating foot 96 has a standoff portion 98 and a tab 100. The standoff portion 98 maintains a gap between the bottom of the cooking surface 38 and the cooking opening 36. The gap allows a place for exhaust gases and heat from the burner 33. The tabs 100 extend into the alignment pockets 58 to prevent side-to-side or front-to-back movement of the griddle 14 when mated to the base 12. In use, the burner 33 heats up the cooking surface 80, with the heat and exhaust gases escaping at the gap between the top surface 38 and the bottom of the griddle 14.

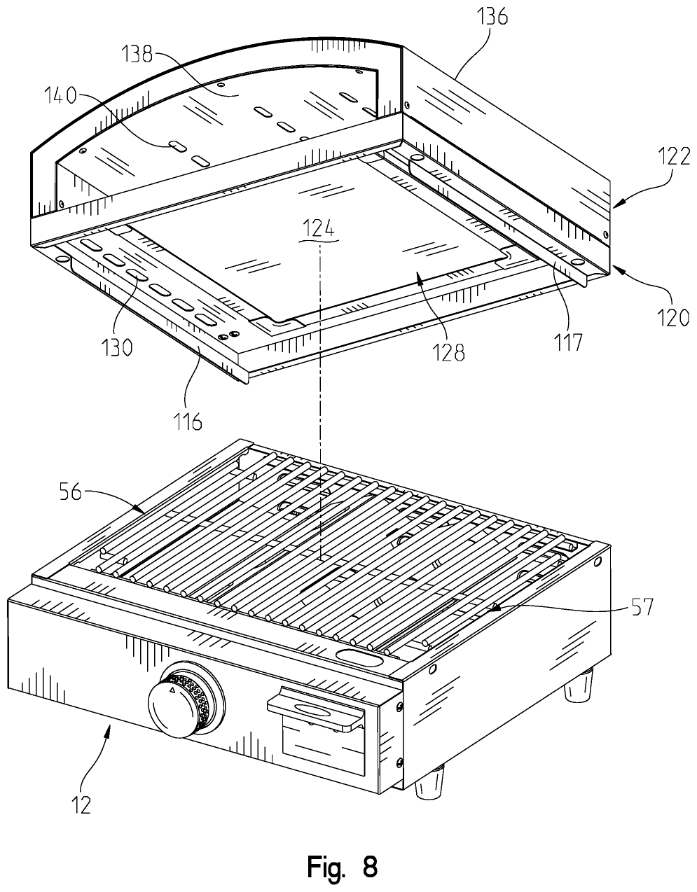

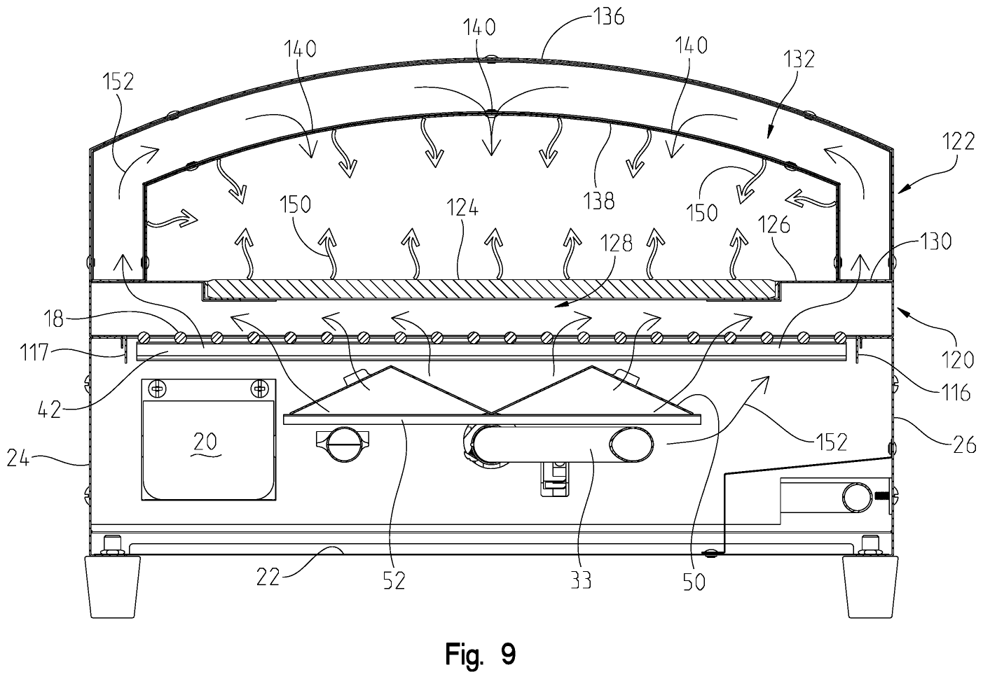

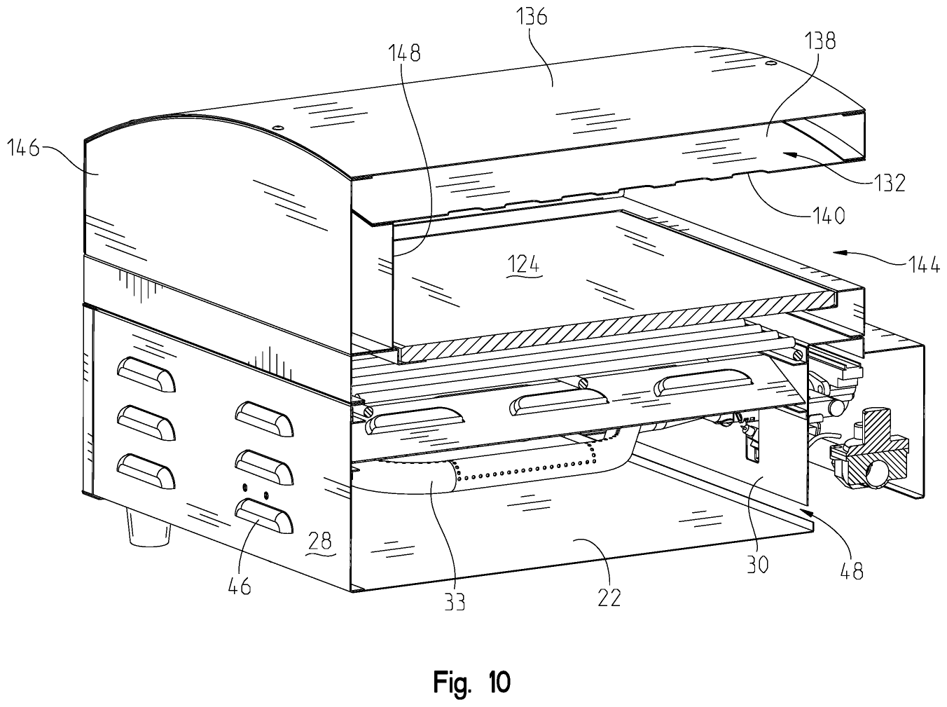

The pizza oven 16 is a partially enclosed attachment that mates to the base 12. The pizza oven 16, as opposed to the griddle 14, sits flush with the top surface 38 and is specifically designed to channel the exhaust gases and heat from the burner 33. This is aided by alignment walls 116, 117 that mate with the receiving gaps 56, 57 on the base 12. In the event the grate 18 is not present, the alignment walls 116, 117 mate with the cooking opening 36. The pizza oven 16 has two main portions: a stone portion 120 and a dome portion 122. The stone portion 120 holds a baking stone 124 that is supported by a bottom wall 126. The bottom wall 126 has a central aperture 128 so the underside of the baking stone 124 is directly exposed to the heat from the burner 33. The stone portion 120 forms part of the enclosure to direct exhaust gases into the dome portion 122 by mating to the cooking opening 36. The fit between the pizza oven 16 and the base 12 reduces or prevents heat loss at the interface between the two parts, along with the alignment walls 116, 117 providing an additional barrier. Openings 130 in the bottom wall 126 direct exhaust gases and heat into a dome chamber 132 in the dome portion 122. The dome portion 122 has an outer wall 136 and an inner wall 138. The inner wall 138 is the only place where exhaust gases can escape, with exhaust openings 140 shown in FIGS. 8-10. The outer wall 136 has no exhaust apertures. FIG. 9 shows a section view of the pizza oven 16 as mated to the base 12. In that same FIG., the hollow arrows represent radiant heat 150 passing through the baking stone 124 and inner wall 138 and the solid arrows represent the flow of exhaust gases 152 and heat from convection. The exhaust gases 152 pass through the exhaust openings 140. The pizza oven 16 has an opening 144 for placing and removing food on the baking stone 124. FIG. 10 shows another section view of the pizza oven 16 as mated to the base 12. Opposite the opening 144 is an inner back wall 148 and an outer back wall 146. The back walls 146, 148 help to keep the heat in the pizza oven 16.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A modular cooking appliance connectable to a fuel supply, said modular cooking appliance comprising:
a base having a bottom wall affixed to side walls and a rear wall, said side walls affixed to a front wall;
said side walls, said front wall, and said rear wall each terminating at a top surface that surrounds a cooking opening, said top surface parallel to and spaced from said bottom wall, said base having a burner located between said bottom wall and said top surface, said front wall has an aperture to receive a grease trap, said grease trap having an open top that aligns with a grease aperture in said top surface when said grease trap is located in said front wall;
a removable flame baffle overlaying said burner and supported by said front wall and said rear wall;
a plurality of interchangeable tops is mateable to said cooking opening;
one of said interchangeable tops is a removable grate, said grate supported by a front support wall and a rear support wall when said grate is located in said cooking opening, said grate is smaller than said cooking opening to form receiving gaps along edges of said grate and alignment pockets at corners of said grate between said cooking opening and said grate;
a second interchangeable top is a pizza oven, said pizza oven having a stone portion in fluid communication with a dome portion, said stone portion having alignment walls to be received by said receiving gaps, said stone portion supporting a baking stone and having apertures to direct exhaust gases from said burner into a dome chamber in said dome portion, said dome portion having an inner wall and an outer wall to form said dome chamber, said inner wall of said dome portion having exhaust openings facing said baking stone, said exhaust gases passing through said exhaust openings; and
wherein said second interchangeable top is mateable to said cooking opening whether or not said removable grate is located in said cooking opening and whether or not said removable flame baffle is overlaying said burner;

2. The modular cooking appliance in claim 2, wherein a third interchangeable top is a griddle having a flat cooking surface, said griddle having locating feet to be received by said alignment pockets when said griddle is connected to said cooking opening, said flat cooking surface having a drain aperture that aligns with said grease aperture when said griddle is connected to said cooking opening.

3. The modular cooking appliance in claim 1, wherein said grate is substantially aligned with said top surface when said grate is located in said cooking opening.

4. The modular cooking appliance in claim 1, wherein said pizza oven directs radiant heat through said baking stone and convection heat through said dome chamber and out said exhaust openings when said burner is lit and said pizza oven is mated to said base.

5. The modular cooking appliance in claim 1, wherein said front wall is spaced from said bottom wall to form a gap to supply said burner with fresh air.

6. A modular cooking appliance connectable to a fuel supply, said modular cooking appliance comprising:
a base having a bottom wall affixed to side walls and a rear wall, said side walls affixed to a front wall;
said side walls, said front wall, and said rear wall each terminating at a top surface that surrounds a cooking opening, said top surface parallel to and spaced from said bottom wall, said base having a burner located between said bottom wall and said top surface;
a removable flame baffle overlaying said burner and supported by said front wall and said rear wall;
a plurality of interchangeable tops is mateable to said cooking opening;
one of said interchangeable tops is a removable grate, said grate supported by a front support wall and a rear support wall when said grate is located in said cooking opening, said grate is smaller than said cooking opening to form receiving gaps along edges of said grate and alignment pockets at corners of said grate between said cooking opening and said grate; and
wherein another of said interchangeable tops is mateable to said cooking opening whether or not said removable grate is located in said cooking opening and whether or not said removable flame baffle is overlaying said burner.

7. The modular cooking appliance in claim 6, wherein said front wall has an aperture to receive a grease trap, said grease trap having an open top that aligns with a grease aperture in said top surface when said grease trap is located in said front wall.

8. The modular cooking appliance in claim 7, wherein said another interchangeable tops is a griddle having a flat cooking surface, said griddle having locating feet to be received by said alignment pockets when said griddle is connected to said cooking opening, said flat cooking surface having a drain aperture that aligns with said grease aperture when said griddle is connected to said cooking opening.

9. The modular cooking appliance in claim 8, wherein said grate is substantially aligned with said top surface when said grate is located in said cooking opening.

10. The modular cooking appliance in claim 6, wherein said another interchangeable tops is a pizza oven, said pizza oven having a stone portion in fluid communication with a dome portion, said stone portion having alignment walls to be received by said receiving gaps, said stone portion supporting a baking stone and having apertures to direct exhaust gases from said burner to said dome portion, said dome portion having an inner wall and an outer wall to form a dome chamber, said inner wall of said dome portion having exhaust openings facing said baking stone, said exhaust gases passing through said exhaust openings.

11. The modular cooking appliance in claim 10, wherein said pizza oven directs radiant heat through said baking stone and convection heat through said exhaust openings in said dome portion when said burner is lit and said pizza oven is mated to said base.

12. The modular cooking appliance in claim 6, wherein said front wall is spaced from said bottom wall to form a gap to supply said burner with fresh air.

13. A modular cooking appliance connectable to a fuel supply, said modular cooking appliance comprising:
a base having a bottom wall affixed to side walls and a rear wall, said side walls affixed to a front wall, said side walls, said front wall, and said rear wall each terminating at a top surface that surrounds a cooking opening, said top surface parallel to and spaced from said bottom wall, said base having a burner located between said bottom wall and said top surface;
a removable flame baffle overlaying said burner and supported by said front wall and said rear wall;
said front wall has an aperture to receive a grease trap, said grease trap having an open top that aligns with a grease aperture in said top surface when said grease trap is located in said front wall; and
a plurality of interchangeable tops is mateable to said cooking opening.

14. The modular cooking appliance in claim 13, wherein one of said interchangeable tops is a grate, said grate supported by a front support wall and a rear support wall when said grate is located in said cooking opening, said grate is smaller than said cooking opening to form receiving gaps and alignment pockets between said cooking opening and said grate.

15. The modular cooking appliance in claim 14, wherein another of said interchangeable tops is mateable to said cooking opening whether or not said removable grate is located in said cooking opening and whether or not said removable flame baffle is overlaying said burner.

16. The modular cooking appliance in claim 13, wherein said another interchangeable tops is a griddle having a flat cooking surface, said griddle having locating feet to be received by said alignment pockets when said griddle is connected to said cooking opening, said flat cooking surface having a drain aperture that aligns with said grease aperture when said griddle is connected to said cooking opening.

17. The modular cooking appliance in claim 13, wherein said another interchangeable tops is a pizza oven, said pizza oven having a stone portion in fluid communication with a dome portion, said stone portion having alignment walls to be received by said receiving gaps, said stone portion supporting a baking stone and having apertures to direct exhaust gases from said burner to said dome portion, said dome portion having an inner wall and an outer wall to form a dome chamber, said inner wall of said dome portion having exhaust openings facing said baking stone.
